(19) United States
(12) Patent Application Publication
(10) Pub. No.: US 2015/0170308 A1
(43) Pub. Date: Jun. 18, 2015

(54) Periodic Survey Scheduling Method and System for Safety Inspector

(71) Applicant: Nippon Gas Co., Ltd., Tokyo (JP)

(72) Inventors: Shinji Wada, Tokyo (JP); Shingo Dekamo, Tokyo (JP)

(73) Assignee: Nippon Gas Co., Ltd., Tokyo (JP)

(21) Appl. No.: 14/414,441

(22) PCT Filed: Jul. 12, 2013
(86) PCT No.: PCT/JP2013/004321

§ 371 Date: Jan. 12, 2015

(30) Foreign Application Priority Data
Jul. 13, 2012 (JP) 2012-158100

(51) Int. Cl. G06Q 50/26; G06Q 50/06; G06Q 10/10

(52) U.S. Cl. CPC G06Q 50/265; G06Q 10/1097; G06Q 50/06

(57) ABSTRACT

The management levels of inspections for LP gas supply facility and consumption facility, and data for the periodic replacement of parts is not the same (for example, the management units are consumption units, facility units, and parts units, and when re-inspecting consumption facility the management units vary, including survey units). Therefore, collective management of deadlines is not possible. In the present safety management system, a request for the deadline expiration data of an LP gas safety task is received, consumption safety data and supply facility safety data, the legal term of which will expire within a fixed period, are acquired and this data is gathered and noted in ascending order according to the legal term expiration date of the LP gas safety task, after which deadline expiration data is generated.

### TECHNICAL FIELD

The present invention relates to a periodic survey scheduling method for safety inspectors and a system therefor. More specifically, the present invention relates to a method and a system for managing a schedule for periodic inspections of supply facility and consumption facility for liquefied petroleum (LP) gas.

### BACKGROUND ART

Conventionally, LP gas is classified into gas imported from producers of industrial gas, and gas generated domestically during the manufacture of petrochemical products. Import stations of storing the LP gas transported by tankers from the industrial gas producers and oil refinery stations are called the primary stations. The LP gas in the primary station is loaded into coastal vessels and tank trucks, and shipped to the secondary stations, which are transit stations located along or away from the coasts. Further, the LP gas carried to the secondary stations is transported to LP gas filling stations (delivery bases) in various places, and is filled in gas cylinders in the delivery bases. The gas cylinders filled with the LP gas in the individual delivery bases are delivered by deliverymen to customers' homes, such as general houses, apartment buildings and offices. This is a supply method with a gas cylinder. Another supply method is a supply system with a gas bulk. This is a method for supplying gas from tank trucks directly to a gas bulk in customer's home. In the description of the present invention, there is a case wherein a gas cylinders and a gas bulk are collectively referred to as “gas cylinders”.

For LP gas supplied by these methods, there is a possibility leading up to pollution, such as a gas leakage or a gas explosion. Therefore, there is a law in Japan for ensuring safety, anti-pollution and optimization of transaction of LP gas as its main purposes. According to the law, gas suppliers are obligated to conduct periodic inspections of LP gas supply facility and consumption facility. It should be noted that the supply facility represents a section extending from a gas cylinder to the outlet of a gas meter. The gas facility is obligated to conduct periodic inspections under administrative control and act responsibly. The consumption facility includes a section extending from the outlet of a gas meter to each gas appliance (e.g., a gas stove or a water heater). This facility is under administrative control and responsibly of a customer, and like the supply facility, a periodic inspection by the gas supplier is required.

There are two types of law for obligating periodic inspections: the “Act on the Securing of Safety and the Optimization of Transaction of Liquefied Petroleum Gas” (hereinafter referred to as the “Liquefied Petroleum Gas Act”) and the “Gas Business Act”, both of which are applied separately based on supply forms. The Liquefied Petroleum Gas Act stipulates, as LP gas supply forms, a direct supply form for delivering gas cylinders to customers (hereinafter referred to as “general supply”) and a form whereby a community gas generator, also called a gas facility, is installed and vaporizes LP gas, and the thus generated gas is supplied through pipelines to a plurality of customers. It should be noted, however, that the Liquefied Petroleum Gas Act is applied for a service area wherein the number of supply destinations, i.e., the number of customers, is less than seventy. In a case wherein the number of customers is seventy or greater, the Gas Business Act is applied. As described above, although the installed facility is the same, the different Act is applied in accordance with the number of supply destinations. To classify the individual supply forms, the supply form employed based on the Liquefied Petroleum Gas Act is called “concentric gas (supply)” and that employed based on the Gas Business Act is called “community gas (supply)”. Further, there is a case wherein for both the concentric gas and the community gas, a gas facility as a supply facility is called a “parent”, while a consumption facility in a customer is called a “child”. It should be noted that the destinations of supply by the gas facility are not a plurality of “consumption facilities”, but a plurality of “customers” (it is possible that a customer owns a plurality of consumption facilities, and eventually, gas supply may be performed for a plurality of consumption facilities).

According to the Liquefied Petroleum Gas Act, a periodic inspection is obligated once every four years for the supply facility and the consumption facility for gas cylinders. Further, in a case wherein re-inspection is required as the result of the periodic inspection for the consumption facility, the re-inspection must be obligated within one month to six months following the inspection date. The requirement for re-inspection is limited to the case of the consumption facility, because the consumption facility is owned by the customer, and the gas supplier can merely request that the customer take a corrective measure. Therefore, when a predetermined period has elapsed from the request, the re-inspection is conducted for the corrective measure. If the corrective measure is not yet taken at the time of re-inspection, and it is determined that it is at high risk to continuously supply gas, it stops supplying gas (so-called a closing cock measure). In contrast, the supply facility belongs to the gas supplier, and the immediate inspection can be conducted if the re-inspection is required, so that any specific period of time for the re-inspection is not stipulated by the Liquefied Petroleum Gas Act.

According to the Gas Business Act, the periodic inspection for every forty months for the consumption facility is obligated. A period for conducting the periodic check of a gas facility, which is supply facility, varies depending on the facility level. More specifically, a daily check is obligated for the facility that employs a system for forcibly vaporizing LP gas by using electricity or a gas, a monthly check is obligated for the facility with an automatic monitoring device being attached, and a weekly check is obligated for the other type of facility. Furthermore, like the Liquefied Petroleum Gas Act, the re-inspection for the consumption facility is obligated within one month to six months following the inspection date.

In addition to the above described inspections, periodic replacement of parts, such as a gas alarm device, a gas meter, a gas pressure regulator and a gas hose, is also performed to provide maintenance and replacement operation for these parts. Since there are many types of parts and different expiry dates are provided for the individual types, it is especially required for the parts to be replaced before their expiry dates are reached.

In the description of this invention, “inspection”, “check” and “survey” are employed in accordance with specific definitions. The “inspection” represents an operation for examining all the facility, including the consumption facility in the customer's home, the “check” represents an operation for examining only the supply facility, and the “survey” represents an extension of “check” for more closely surveying the supply facility. Further, in some cases, the “inspection”, the “check” and the “survey” are collectively referred to as the “inspection”. The inspection operation and the part replacement operation are collectively called a safety operation.

The due dates for these inspections of the LP gas supply facility and consumption facility and for periodic replacement of parts are managed, and the safety operation is assigned to the safety inspectors.

However, at present, the individual inspections for the LP gas supply facility and consumption facility and the periodic replacement of parts are managed by using a database, but the levels for management of data are not standardized (for example, management is performed on a customer-by-customer basis, a facility-by-facility basis, or a parts-by-parts basis, and in a case wherein re-inspection is required for the consumption facility, the basis to conduct the inspection is varied). Thus, collective due date management cannot be performed. For the current due date management, the safety manager, for example, periodically performs a manual operation and obtains various data from a database. Further, when a case wherein the safety inspection has been completed or the cock has been closed should be excluded from the objects for the due date management (a case wherein the cock is closed is not regarded as an object for the periodic inspection because the safety operation should be always performed at the time of opening the cock), this operation is also fully manually performed. Furthermore, it is more appropriate that the case to be excluded from the object for the due date management is where the inspection was assigned to the safety inspector, not where the safety inspection has been completed, because acquisition of unnecessary data is unnecessary. Therefore, a method and a system for performing collective management for the due dates of the individual inspections of LP gas supply facility and consumption facility and for the expiry dates of periodic replacements of parts have been requested.

### SUMMARY OF INVENTION

In order to achieve this objective, according to the present invention, a method for creating due date data for LP gas safety operations in a safety management system comprising a customer safety data storage unit for storing, at least, due date data for a statutory inspection of consumption facility associated with LP gas, and a supply facility safety data storage unit for storing, at least, due date data for a statutory inspection of supply facility associated with LP gas, the method comprising:
receiving a request instruction for the due date data;
in response to receiving the request instruction, obtaining, from the customer safety data storage unit, customer safety data indicating that a due date will be reached within a prescribed period of time;
in response to receiving the request instruction, obtaining, from the supply facility safety data storage unit, supply facility safety data indicating that a due date will be reached within a prescribed period of time; and
sorting the obtained customer safety data and the obtained supply facility safety data collectively in an ascending order of statutory due dates for LP gas safety operations to create the due date data.

Further, the present invention described in the foregoing paragraph is characterized in that:
the safety management system further comprises a parts management data storage unit, for storing expiry dates for parts of, at least, the consumption facility and/or the supply facility associated with LP gas, and wherein the method further comprises in response to receiving the request instruction, obtaining, from the parts management data storage unit, parts management data indicating that the expiry date will be reached within a prescribed period of time, and wherein creating the due date data includes:
collectively sorting the obtained customer safety data, the obtained supply facility safety data and the obtained parts management data in an ascending order of the due dates of the LP gas safety operations and the expiry dates of parts to create the due date data; and
collecting, from the created due date data, at least data related to the same customers.

The invention described in the foregoing paragraph is characterized in that:

obtaining the customer safety data, and obtaining the supply facility safety data, from acquisition of data, at least one of data indicating that a state of LP gas supply to a customer is closing cock, data indicating that an LP gas safety operation associated with the due date data has been already completed, and data indicating that an LP gas safety operation associated with the due date data has been already assigned to a safety inspector.

The invention described in the three foregoing paragraphs is characterized in that:

the safety management system further comprises a safety inspector data storage unit, for storing safety inspector data performing the LP gas safety operation, and wherein the method further comprises:
receiving an assignment instruction for assigning, to individual safety inspectors, LP gas safety operations associated with the due date data,
in response to receiving the assignment instruction, associating the due date data with the safety inspector data,
receiving scheduled operation dates for LP gas safety operations related to the associated due date data,
registering the received scheduled operation dates,
creating safety operation schedule data for the individual safety inspectors based on the registered scheduled operation dates and the due date data, and
transmitting the created schedule data to mobile terminals of the individual safety inspectors.

The invention described in the four forgoing paragraphs is characterized by further comprising the steps of:
receiving operation completion data for LP gas safety operations associated with the due date data;
determining, based on the received operation completion data, whether re-operation is required;
calculating a due date for the re-operation in a case where the re-operation is required, and
calculating a due date for a next operation in a case where the re-operation is not required.

### ADVANTAGEOUS EFFECTS OF INVENTION

As described above, according to the present invention, the due dates for the individual inspections of the LP gas supply facility and consumption facility and for the replacements of parts can be collectively managed.

### BRIEF DESCRIPTION OF DRAWINGS

FIG. 1 is a diagram illustrating a network configuration according to one embodiment of the present invention;

FIG. 2 is a block diagram illustrating the configuration of a safety management server according to the embodiment of the present invention;

FIG. 3 is a diagram showing example information stored in a customer safety data storage unit according to the embodiment of the present invention;

FIG. 4 is a diagram showing example information stored in a supply facility safety data storage unit according to the embodiment of the present invention;

FIG. 5 is a diagram showing example information stored in an alarm device data storage unit according to the embodiment of the present invention;

FIG. 6 is a diagram showing example information stored in a due date data storage unit according to the embodiment of the present invention;

FIG. 7 is a diagram showing example information stored in a safety inspector data storage unit according to the embodiment of the present invention;

FIG. 8 is a diagram showing example information stored in a schedule data storage unit according to the embodiment of the present invention;

FIG. 9 is a flowchart showing the safety inspection scheduling processing according to the embodiment of the present invention; and

FIG. 10 is a flowchart showing the next due date calculation processing according to the embodiment of the present invention.

### DESCRIPTION OF EMBODIMENT

A safety management system according to one embodiment of the present invention will now be described while referring to the accompanying drawings.

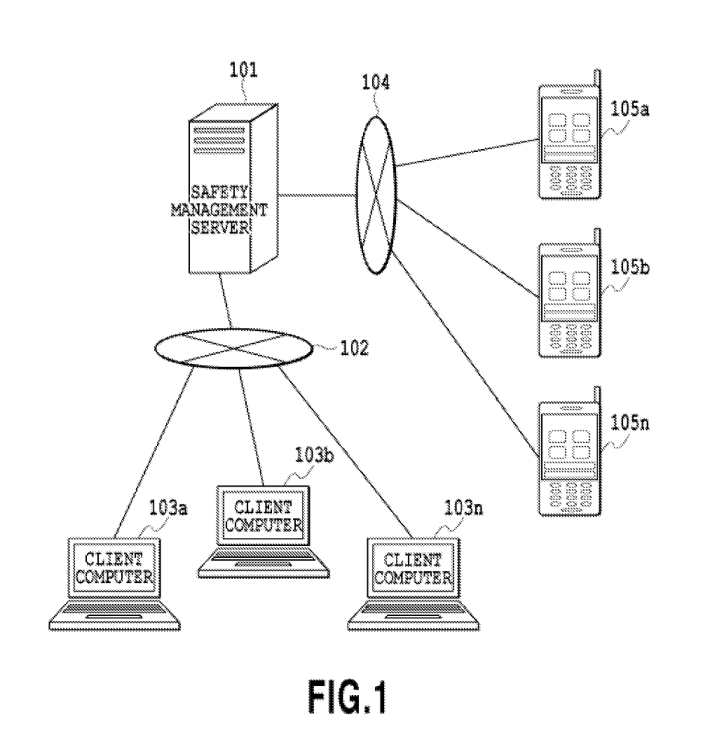

FIG. 1 is a diagram illustrating a network configuration according to the embodiment of the present invention. In FIG. 1, a safety management server 101located in, for example, the headquarters of a company is configured to communicate via a network 102 with a plurality of client computers 103a, 103b, . . . and 103n (hereinafter, collectively referred to as client computers 103) located in, for example, individual branch offices. The safety management server 101 is also configured to communicate via a network 104 with a plurality of mobile terminals 105a, 105b, . . . and 105n (hereinafter referred to as mobile terminals 105).

Upon receipt of a request from the client computer 103, the safety management server 101 obtains and accumulates data (due date data) representing the due date of a periodic statutory inspection and the expiry date of parts (e.g., the time limit of replacement of parts) will be reached within a prescribed period of time (e.g., the next three months), and transmits the resultant data to the client computer 103.

The thus obtained due date data is output to the client computer 103. Based on the received data, a person in charge of assigning the safety inspections, for example, assigns safety operations to the safety inspectors. The safety inspectors make an appointment with customers and determine scheduled operation dates based on the safety inspection assignment data. The safety inspectors register the determined scheduled operation dates at the safety management server 101 through the client computers 103. In response to this registration, the safety management server 101 prepares schedule data, and distributes the schedule data to the mobile terminals 105 of the safety inspectors to whom the inspections are assigned.

The safety inspectors perform the safety inspection in accordance with the assigned schedule data. The safety inspectors enter the operation results by employing the client computers 103 and/or the mobile terminals 105.

When the operation results are received, the safety management server 101 calculates, for the next safety inspection, the statutory due dates of the periodic inspections and the expiry dates of the parts, and updates the data. Further, in a case wherein it is determined based on the operation results that the re-inspection is required, the safety management server 101 calculates the statutory due date for re-inspection, and updates the data.

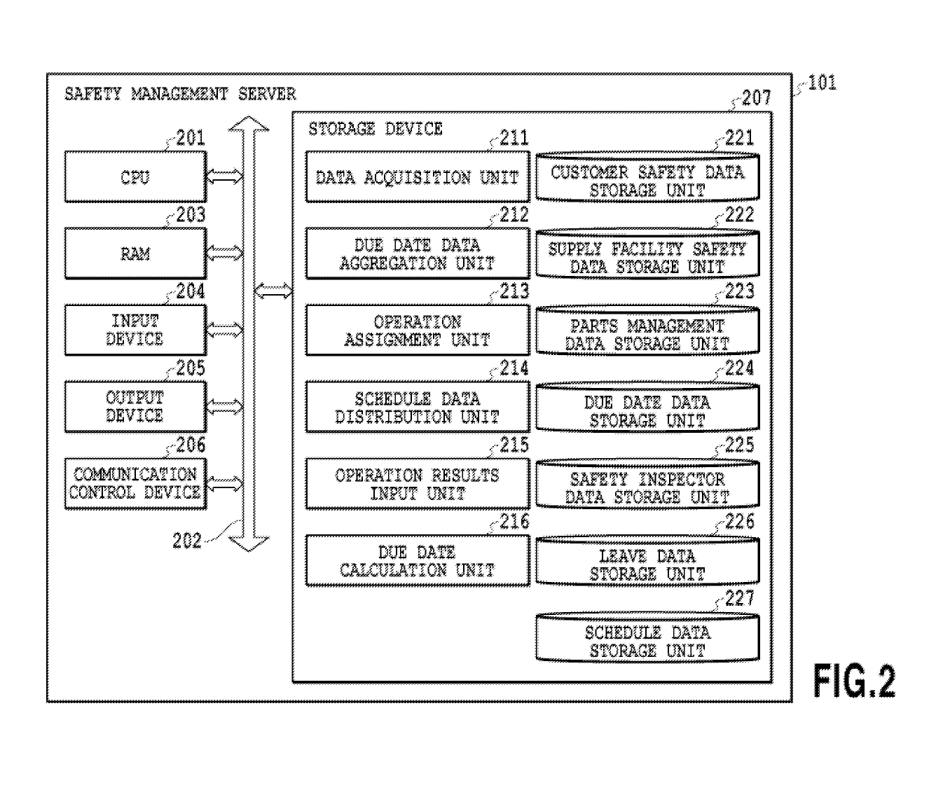

The above described configuration of the safety management server 101 will now be described in detail, while referring to the block diagram in FIG. 2. Referring to FIG. 2, only necessary functions are illustrated on the assumption of the usage of a single computer system; however, the safety management server 101 may also be provided as one part of a distributed multi-function system that includes a plurality of computer systems.

The safety management server 101 has a configuration wherein a RAM 203, an input device 204, an output device 205, a communication control device 206 and a storage device 207 including a nonvolatile storage medium (a ROM, an HDD, etc.) are coupled to a CPU 201 via a system bus 202. The storage device 207 includes a program storage area to store a software program, for performing the individual functions of the safety management system, and a data storage area to store, for example, data acquired as needed and data indicating the processing results. The individual units in the program storage area to be explained below are actually independent software programs and the routines or components thereof. The individual units perform the corresponding functions by being retrieved from the storage device 207 by the CPU 201, loaded into the work area of the RAM 203, and being sequentially executed while properly referring to a database, etc.

The data storage area includes a customer safety data storage unit 221, a supply facility safety data storage unit 222, a parts management storage unit 223, a due date data storage unit 224, a safety inspector data storage unit 225 and a schedule data storage unit 226 when only those units that are related to the present invention are provided. All of these storage units are predetermined storage areas reserved in the storage device 207.

The customer safety data storage unit 221 stores, for each customer, data related to the safety inspection. In this embodiment, the customer safety data storage unit 221 includes “Due Date” representing the next due date for the periodic inspection, “Re-inspection Due Date” representing the due date of re-inspection in a case wherein the re-inspection is required, “Customer Classification” representing the customer facility, the general supply, the concentric gas supply, or the community gas supply form, “Cock Status” representing a cock-opened state or a cock-closed state indicating the supply of gas to the customer, and “Code of Office in Charge” used to identify an office in charge. In a case wherein a pass decision is obtained as the result of the safety inspection (a case wherein it is determined the re-inspection is not required), the next due date is calculated and “Due Date” is updated by using this data. In a case wherein a fail decision is obtained as the result of the safety inspection, “Due Date” is updated after the re-inspection is completed. “Re-inspection Due Date” is calculated and stored in a case wherein the fail decision is obtained as the operation result. It should be understood for one having ordinary skill in the art that it is not necessary to immediately calculate and store all of the due dates, and night batch processing can be performed to calculate all of these due dates.

The supply facility safety data storage unit 222 stores, for each piece of supply facility, information related to the safety inspection. In this embodiment, the supply facility safety data storage unit 222 stores “Supply Facility Code” used to identify the supply facility, “LPG Due Date” representing the next due date for the supply facility and “Code of Office in Charge”. When the results of the safety inspection are entered, the next due date is calculated and is reflected to “LPG Due Date”. It should be understood by one having ordinary skill in the art that calculation and storage of the due date also need not be immediately performed.

The parts management data storage unit 223 stores, for each of parts to be replaced, information related to the safety inspection. In this embodiment, the parts management data storage unit 223 stores “Customer Code”, “Customer No.” used to identify an alarm device (in case of a gas meter, “Meter No.”, etc.), “Model Type”, “Serial Number”, “Manufacturing Date” and “Expiry Date” representing the date required for replacement of parts. Since for the individual customers, there is normally a plurality of parts to be replaced, such as alarm devices, “Customer No.” is employed as a number to identify each alarm device in the house of the same customer.

The due date data storage unit 224 stores information representing that the statutory due date for the periodic inspection and the expiry date for parts (i.e., the date for replacement of parts) will be reached within a prescribed period of time (e.g., within the next three months). In this embodiment, the due date data storage unit 224 stores “ID” representing the unique sequential number to uniquely identify an operation, “Operation Contents” representing the specific contents of the safety operation, “Due Date”, “Customer Facility Code” used to identify a customer and/or facility, “Scheduled Operation Date” representing the date for performing the safety inspection, “Code of Office in Charge”, “Name of Office in Charge” and “Code of Safety Inspector in Charge” used to identify a safety inspector in charge of the safety inspection. Since a plurality of operations might be collectively performed in a case wherein the due dates for those operations are the same, data for “Operation Contents” can be collectively stored by, for example, being delimited using commas.

The safety inspector data storage unit 225 stores information for safety inspectors. In this embodiment, the safety inspector storage unit 225 stores “Safety Inspector Code” used to identify a safety inspector, “Name” representing the name of the safety inspector and “Code of Office for Safety Inspector” used to identify the office to which the safety inspector belongs.

The schedule data storage unit 226 stores schedule data to be distributed to the safety inspectors. In this embodiment, “ID”, “Operation ID” used to identify an operation, “Operation Contents”, “Scheduled Operation Date” and “Code of Safety Inspector in Charge” are also stored.

The software program stored in the program storage area includes a data acquisition unit 211, a due date data aggregation unit 212, an operation assignment unit 213, a schedule data distribution unit 214, an operation results input unit 215 and a due date calculation unit 216 where those units only related to the present invention are provided.

The data acquisition unit 211 obtains predetermined data from the storage unit of the data storage area. The data acquisition unit 211 first obtains, from the customer safety data storage unit 221, customer safety data representing that the statutory due date for the periodic inspection will be reached within a prescribed period of time (e.g., within the next three months).

The data acquisition unit 211 also obtains supply facility safety data from the supply facility safety data storage unit 222. Further, the data acquisition unit 211 obtains, from the parts management data storage unit 223, parts management data representing that the expiry date for parts (i.e., the date for the replacement of parts) will be reached within a prescribed period of time. Moreover, the data acquisition unit 211 obtains safety inspector data from the safety inspector data storage unit 225.

The due date data aggregation unit 212 collects and aggregates the obtained customer safety data, the obtained supply facility safety data and the obtained parts management data, and generates a set of due date data. The thus generated due date data is stored in the due date data storage unit 224.

The operation assignment unit 213 transmits the due date data to the client computers 103, etc. Further, the operation assignment unit 213 receives information of an instruction issued by the safety manager for assigning the operations to the safety inspectors by referring to the due date data, and transmits a notification to that effect to the individual safety inspectors through the client computers 103 and/or the mobile terminals 105.

The schedule data distribution unit 214 receives scheduled operation dates that are determined and transmitted through the client computers 103 and/or the mobile terminals 105 by the safety inspectors who received the notification and, for example, made an appointment with customers, and generates schedule data for the safety inspectors. The schedule data distribution unit 214 distributes the generated schedule data to the mobile terminals 105 of the individual safety inspectors. It should be noted that the generated schedule data is stored in the schedule data storage unit 227.

The operation results input unit 215 receives operation results data that are obtained by the safety inspectors through the actual safety inspection, and are entered using the client computers 103 and/or the mobile terminals 105.

The due date calculation unit 216 calculates the next due date and the next expiry date in response to the received operation results information, and updates the due dates and the expiry dates for use in the customer safety data storage unit 221, the supply facility safety data storage unit 222 and/or the parts management data storage unit 223. It should be noted that in a case wherein it is determined based on the received operation results information that re-inspection is required, the due date calculation unit 216 calculates the due date for the re-inspection, and updates the due date for re-inspection in the customer safety data storage unit 221.

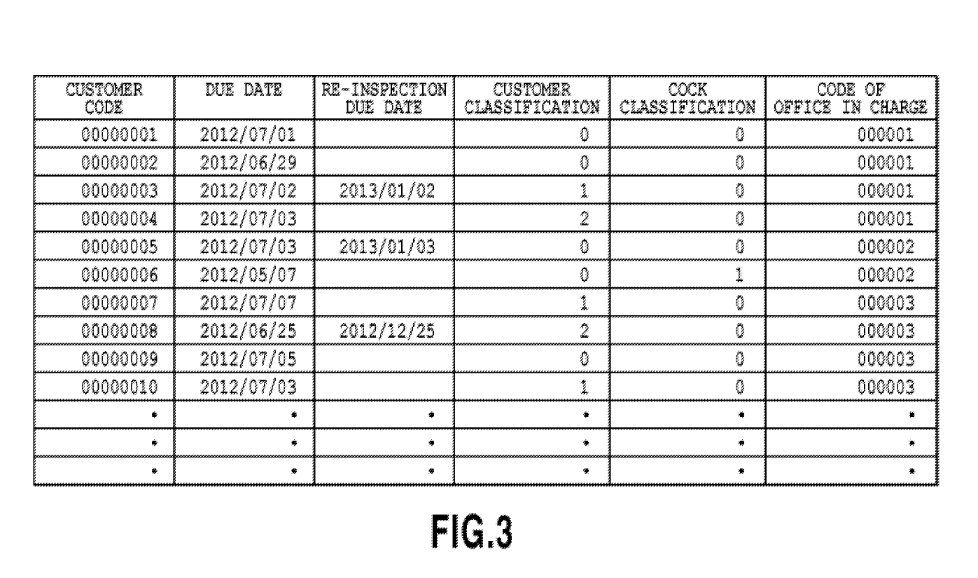

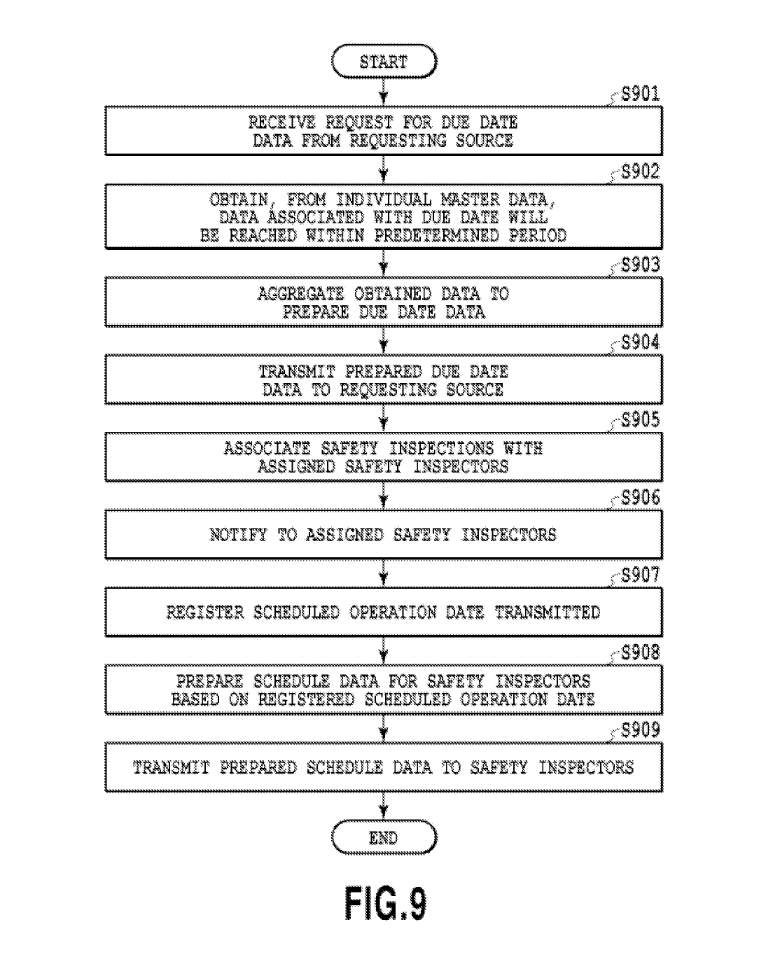

The safety inspection scheduling processing performed for this embodiment will now be described in detail, while referring to the flowchart in FIG. 9 and tables in FIGS. 3 to 8.

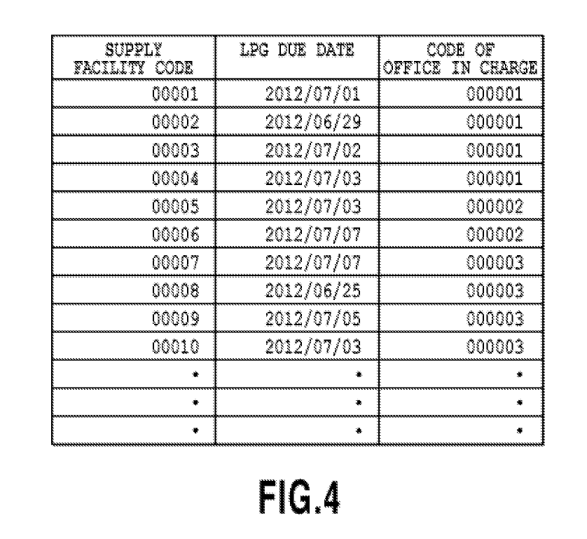

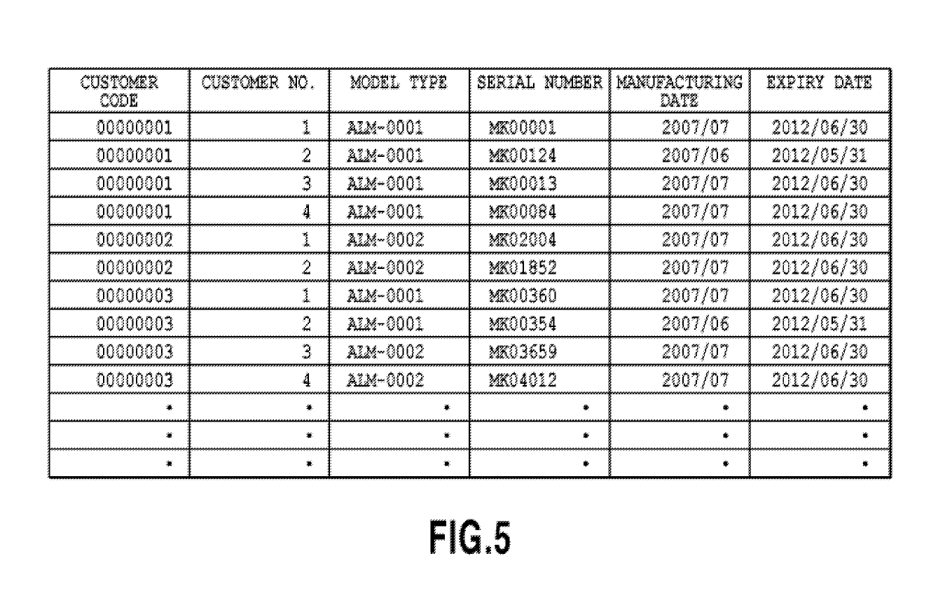

First, at step 901, the data acquisition unit 211 receives an instruction from a requesting source (e.g., the client computer 103 operated by the safety manager) for requesting the due date data. In response to the receipt of the request instruction, the data acquisition unit 211 extracts, from the customer safety data (FIG. 3) stored in the customer safety data storage unit 221, the supply facility safety data (FIG. 4) stored in the supply facility safety data storage unit 222 and the parts management data (FIG. 5) stored in the parts management data storage unit 223, data associated with the due date will be reached within a prescribed period of time (e.g., the next three months) from the processing date (system date) (step 902). In this case, the customer safety data (FIG. 3) includes data for each customer by employing the customer code as the main key, i.e., data related to the consumption facility. The supply facility safety data (FIG. 4) includes data for each piece of supply facility by employing the supply facility code as the main key, i.e., data related to the supply facility. Further, data related to the alarm device is shown in FIG. 5 as an example for the parts management data, and it should be understood that master data (not shown) related to other parts (a gas meter, a regulator, a gas hose, etc.) are also obtained. When identifiers are provided according to the types of parts, data for the individual parts, such as the alarm device and the gas meter, can also be managed as the same master data, instead of separate master data for these parts.

In a case wherein data is present in “Re-inspection Due Date” for the customer safety data as the result of data acquisition at step 902 (in a case, to be described later in detail, wherein the fail decision is obtained through the periodic inspection and re-inspection is required), data representing that “Re-inspection Due Date” will be reached within a prescribed period of time from the processing date is obtained. In a case wherein the re-inspection due date is not present as the result of the data acquisition, data representing that “Due Date” will be reached within a prescribed period of time from the processing date is obtained.

Further, data representing that “LPG Due Date” falls within a prescribed period of time from the processing date is obtained from the supply facility safety data, and data representing that “Expiry Date” falls within the specific period of time from the processing date is obtained from the parts management data.

At step S902, only a specified office may be chosen by using “Code of Office for Safety Inspector” to perform the data acquisition, or may be omitted, based on “Cock Classification”, from the targets to perform the data acquisition. Furthermore, data representing that the operation has been already completed or data representing that assignment of the operation to the safety inspectors has been completed can also be excluded. Further, “Customer Classification” of the customer safety data is not employed at this stage. This is employed for calculating the due date, which will be described later in detail.

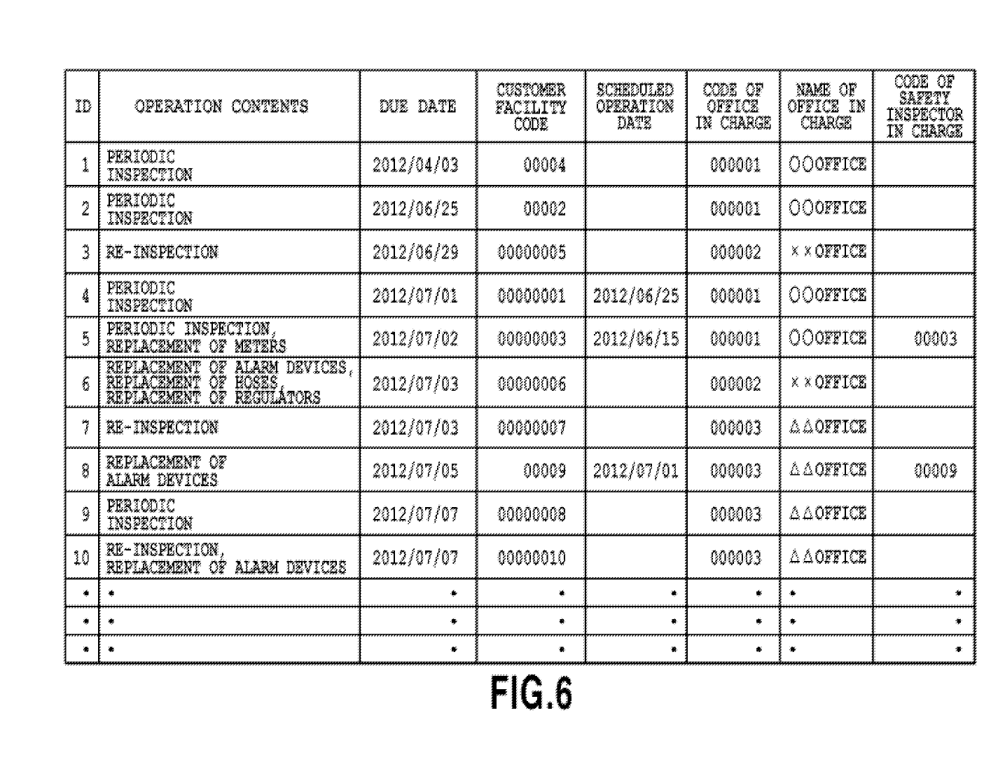

Following this, the due date data aggregation unit 212 sorts the obtained safety and parts management data in an ascending order of the due dates to prepares due date data (FIG. 6) (step 903). For “Operation Contents” of the due date data, the title describing the corresponding operation contents is obtained from different data (not shown), and is entered. At this time, a plurality of titles representing the operation contents can be stored by being delimited with commas, so that the obtained customer safety data and the obtained parts management data, for which the customer codes are matched (in FIG. 6, data with “IDs” of 5, 6 and 10), can be held in one record of the due date data. In a case wherein an acquisition source is the customer safety data or the parts management data, the customer code is entered at “Customer Facility Code”, or in a case wherein the source of data acquisition is the supply facility safety data, the supply facility code is entered. Since “Scheduled Operation Date” is determined and entered after the assignment of the safety inspections to the safety inspectors has been performed, null data is present at the stage of preparing the due date data. Furthermore, for “Code of Safety Inspector in Charge”, the safety inspector code of the safety inspector that is in charge of the safety inspection is entered in the process for assigning the safety inspection to the safety inspectors.

Subsequently, the due date data aggregation unit 212 transmits the prepared due date data to the requesting source (step 904). When the due date data is received, the requesting source (e.g., the client computer 103 employed by the safety manager) can display a list of due date data through the output device. At this time, the due date data may also be output by employing a CSV (Comma Separated Values) file.

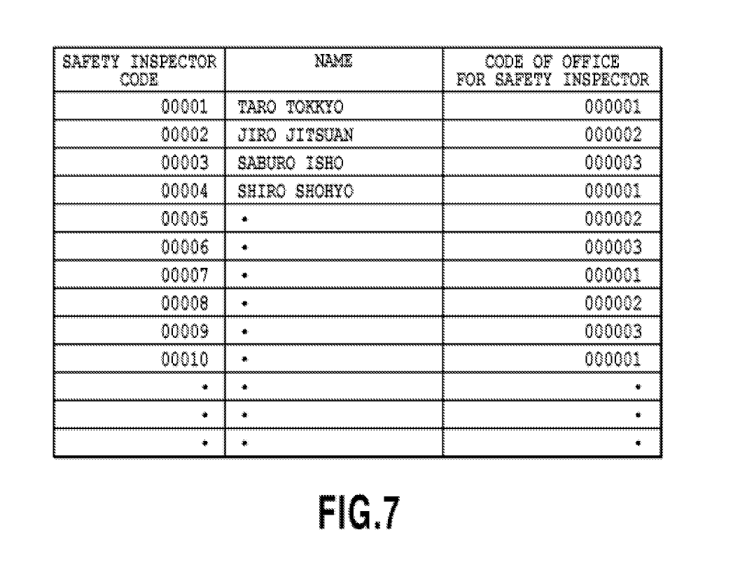

When the due date data prepared at step 904 has been received by the requesting source, the safety manager assigns the safety inspections to the individual safety inspectors based on the due date data. The assignment of the safety inspection is performed by, for example, selecting the individual safety inspections through the input device, and choosing the safety inspectors to whom the selected safety operations are to be assigned. At this time, the safety inspectors to be selected can be narrowed down by using the “Code of Office for Safety Inspector” included in the safety inspector data (FIG. 7) to specify the safety inspectors of the office where the safety manager belongs. When the safety inspection assignment data prepared by the safety manager is transmitted from the client computer 103 to the safety management server 101, the operation assignment unit 213 associates the safety inspectors with the assigned safety inspections (step 905). More specifically, the safety inspector code of the safety inspector, to whom the operation is assigned, is entered to the “Code of Safety Inspector in Charge” of the pertinent record of the due date data.

When safety inspection is assigned (when the safety inspection and the safety inspector are associated with each other at step 905), the operation assignment unit 213 notifies to the mobile terminals 105 of the assigned safety inspectors (step 906). The individual safety inspectors receive the notification through the mobile terminals 105, and determine the scheduled operation dates (by, for example, making an appointment with the customers). The individual safety inspectors thereafter transmit the determined scheduled operation dates to the safety management server 101 through the mobile terminals 105.

The safety management server 101 receives the scheduled operation dates, and registers these dates (step 907). More specifically, the scheduled operation dates thus received are entered to the “Scheduled Operation Date” columns of the pertinent records of the due date data.

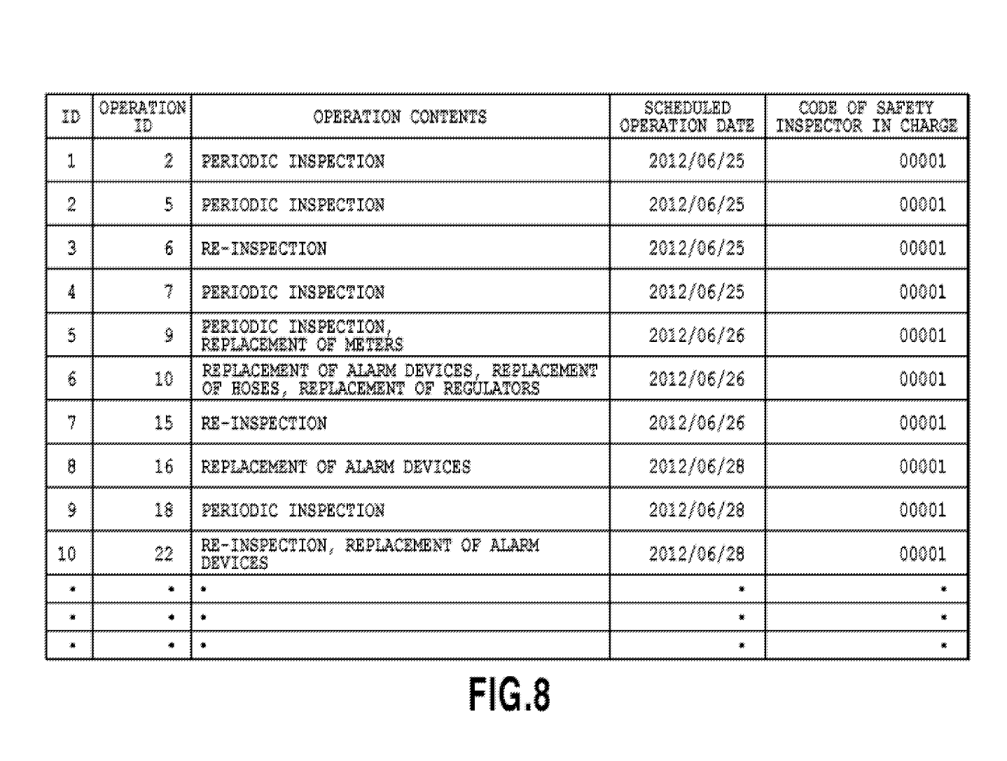

When the scheduled operation dates have been registered, the schedule data distribution unit 214 prepares schedule data (FIG. 8) for the safety inspectors based on the registered, scheduled operation dates (by sorting the dates, for example) (step 908). The schedule data for the safety inspector in FIG. 8 is data only for the safety inspector in charge having the code “00001”; however, it should be understood that the number of sets of schedule data for the safety inspectors are present equivalent to the number of safety inspectors to whom the safety inspection is assigned. Further, “Operation ID” corresponds to the identifier to uniquely identify the operation, i.e., the ID of the due date data (FIG. 6). Furthermore, the operation priority in a case wherein the scheduled operation dates are fixed on the same day can also be added to the data entries in FIG. 8.

When the schedule data distribution unit 214 has prepared the schedule data, the schedule data distribution unit 214 transmits the schedule data to the mobile terminals 105 of the appropriate safety inspectors (step 909). After step 909, the processing is terminated. The mobile terminal 105 displays the received schedule data on a list, or for each day. The individual safety inspectors are to perform the safety inspections based on the schedule data.

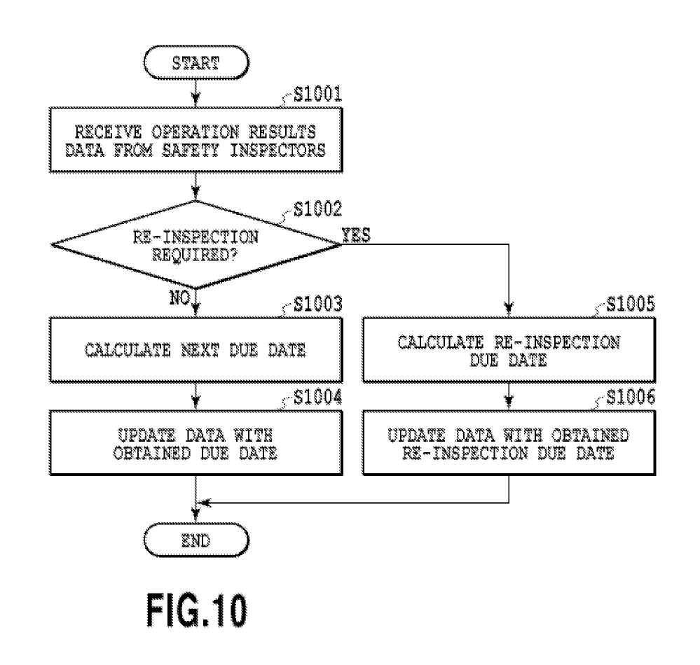

The next due date calculation processing for the embodiment will now be described in detail, by referring to the flowchart in FIG. 10 and tables in FIGS. 1 to 3. The calculation of the next due date is performed after a notification for the completion of the operation has been received from the safety inspectors.

At step 1001, the safety management server 101 receives operation results data (not shown) from the safety inspectors through the mobile terminals 105. The operation results data are, for example, the operation ID (corresponding to the operation ID in FIG. 8), the actual date of operation, the results for the individual inspection entries and the pass/fail decisions of the inspections.

When the operation results data is received, the safety management server 101 determines whether re-inspection is required (step 1002). It may be determined that re-inspection is required in a case wherein, for example, the operation results data represents “Fail” as the pass/fail decision for the inspection, or it may also be determined based on the results of the individual inspection entries. Furthermore, since as described above, the consumption facility is the only target in the safety operation to be handled for the re-inspection, the object for the re-inspection at step 1002 is limited to “Child”, including the consumption facility, for general supply or concentric gas, and “Child” for community gas form. These targets can be identified by associating the IDs of the due date data (FIG. 6) with the operation IDs in the operation results data, and by referring to the customer facility code of the due date data. That is, in a case wherein the customer facility code is the customer code, the corresponding record is data related to the consumption facility. However, since in this case, the data may represent replacement of parts, a determination as to whether the corresponding record is present in the parts management data (FIG. 5) should be performed.

In a case wherein it is ascertained at step 1002 that the re-inspection is not necessary, program control advances to No, and the due date calculation unit 216 calculates the next due date (step 1003). The next due date is obtained by adding a predetermined period of time, such as a period prescribed by law, to the actual date of operation (strictly speaking, further by subtracting one day because the operation must be completed by the previous day of the due date). The predetermined period is “four years” prescribed by the Liquefied Petroleum Gas Act in a case wherein “Customer Facility Code” is the supply facility code. In a case wherein “Customer Facility Code” is the customer code, or a case wherein “Customer Classification” of the customer safety data (FIG. 3) is the general supply or the concentric gas supply, the predetermined period of time is also “four years”. In a case wherein “Customer Classification” is the community gas supply form, the predetermined period of time is “forty months” prescribed by the Gas Business Act. These periods can be held as separate master data. It should be noted, however, that in case of replacement of parts, the predetermined period of time is a period until the expiry date of each of parts (not shown; this data can be held as parts management data or as different master data). Further, the initial date for calculation of the due date after the re-inspection has been performed is not the actual date of operation, but the date where the term expired (i.e., a date six months before). This is regulated by the Liquefied Petroleum Gas Act and the Gas Business Act.

Next, “Customer Classification” is updated using the obtained due date (step 1004). In a case wherein the contents of the safety inspection represent the inspection of the consumption facility, the update destination is “Due Date” of the customer safety data (FIG. 3). In a case wherein the contents of the safety inspection represent the inspection of the supply facility, the update destination is “LPG Due Date” of the supply facility data (FIG. 4). Further, in a case wherein the contents of the safety inspection represent replacement of parts, the update destination is “Expiry Date” of the parts management data (FIG. 5). Furthermore, in a case wherein the contents of the safety inspection represent the inspection of the consumption facility, “Re-inspection Due Date” of the customer safety data (FIG. 3) is updated with null data, etc., and is initialized. This is because of preventing data stored in “Re-inspection Due Date” from being maintained in a case wherein the inspection to be conducted for the consumption facility is re-inspection. After step 1004, the processing is terminated.

In a case wherein it is ascertained, at step 1002, that re-inspection is required, program control proceeds to “Yes”, and the due date calculation unit 216 calculates the re-inspection due date (step 1005). In the same manner as for the due date, the re-inspection due date is obtained by adding a period prescribed by law (six months) to the actual date of operation, and by subtracting one day. A period till the re-inspection due date is currently “six months” (both by the Liquefied Petroleum Gas Act and by the Gas Business Act); however, likewise the due date, a different period may be designated by referring to “Customer Classification”.

The due date calculation unit 216 performs updating by using the obtained re-inspection due date (step 1006). The update destination is “Re-inspection Due Date” of the customer safety data (FIG. 3). However, in a case wherein the re-inspection due date for the supply facility is managed, an additional data entry may be provided for the supply facility safety data (FIG. 4). After step 1006, the processing is terminated.

1. A method for creating due date data for LP gas safety operations in a safety management system comprising a customer safety data storage unit for storing, at least, due date data for a statutory inspection of consumption facility associated with LP gas, and a supply facility safety data storage unit for storing, at least, due date data for a statutory inspection of supply facility associated with LP gas, the method comprising:
receiving a request instruction for the due date data;
in response to receiving the request instruction, obtaining, from the customer safety data storage unit, customer safety data indicating that a due date will be reached within a prescribed period of time;
in response to receiving the request instruction, obtaining, from the supply facility safety data storage unit, supply facility safety data indicating that a due date will be reached within a prescribed period of time; and
sorting the obtained customer safety data and the obtained supply facility safety data collectively in an ascending order of statutory due dates for LP gas safety operations to create the due date data.

2. The method according to claim 1, wherein the safety management system further comprises a parts management data storage unit, for storing expiry dates for parts of, at least, the consumption facility and/or the supply facility associated with LP gas, and wherein the method further comprises in response to receiving the request instruction, obtaining, from the parts management data storage unit, parts management data indicating that the expiry date will be reached within a prescribed period of time, and wherein creating the due date data includes:
collectively sorting the obtained customer safety data, the obtained supply facility safety data and the obtained parts management data in an ascending order of the due dates of the LP gas safety operations and the expiry dates of parts to create the due date data; and
collecting, from the created due date data, at least data related to the same customers.

3. The method according to claim 1, wherein obtaining the customer safety data, and obtaining the supply facility safety data, from acquisition of data, at least one of data indicating that a state of LP gas supply to a customer is closing cock, data indicating that an LP gas safety operation associated with the due date data has been already completed, and data indicating that an LP gas safety operation associated with the due date data has been already assigned to a safety inspector.

4. The method according to claim 1, wherein the safety management system further comprises a safety inspector data storage unit, for storing safety inspector data performing the LP gas safety operation, and wherein the method further comprises:
receiving an assignment instruction for assigning, to individual safety inspectors, LP gas safety operations associated with the due date data,
in response to receiving the assignment instruction, associating the due date data with the safety inspector data,
receiving scheduled operation dates for LP gas safety operations related to the associated due date data,
registering the received scheduled operation dates,
creating safety operation schedule data for the individual safety inspectors based on the registered scheduled operation dates and the due date data, and
transmitting the created schedule data to mobile terminals of the individual safety inspectors.

5. The method according to claim 1, further comprising:
receiving operation completion data for LP gas safety operations associated with the due date data;
determining, based on the received operation completion data, whether re-operation is required;
calculating a due date for the re-operation in a case where the re-operation is required, and
calculating a due date for a next operation in a case where the re-operation is not required.

6. A computer readable storage medium having computer executable instructions for causing a safety management system to perform a method for creating due date data for LP gas safety operations, the safety management system comprising a customer safety data storage unit for storing, at least, due date data for a statutory inspection of consumption facility associated with LP gas, and a supply facility safety data storage unit for storing, at least, due date data for a statutory inspection of supply facility associated with LP gas, the method comprising:
receiving a request instruction for the due date data;
in response to receiving the request instruction, obtaining, from the customer safety data storage unit, customer safety data indicating that a due date will be reached within a prescribed period of time;
in response to receiving the request instruction, obtaining, from the supply facility safety data storage unit, supply facility safety data indicating that a due date will be reached within a prescribed period of time; and
sorting the obtained customer safety data and the obtained supply facility safety data collectively in an ascending order of statutory due dates for LP gas safety operations to create the due date data.

7. A safety management system for creating due date data for LP gas safety operations, the system comprising:
a customer safety data storage unit for storing, at least, due date data for a statutory inspection of consumption facility associated with LP gas;
a supply facility safety data storage unit for storing, at least, due date data for a statutory inspection of supply facility associated with LP gas;
a data acquisition unit for receiving a request instruction for the due date data, and for, in response to receiving the request instruction, obtaining, from the customer safety data storage unit, customer safety data indicating that a due date will be reached within a prescribed period of time, and for, in response to receiving the request instruction, obtaining, from the supply facility safety data storage unit, supply facility safety data indicating that a due date will be reached within a prescribed period of time; and
a due date data aggregation unit for sorting the obtained customer safety data and the obtained supply facility safety data collectively in an ascending order of statutory due dates for LP gas safety operations to create the due date data.

8. The method according to claim 2, wherein obtaining the parts management data, from acquisition of data, at least one of data indicating that a state of LP gas supply to a customer is closing cock, data indicating that an LP gas safety operation associated with the due date data has been already completed, and data indicating that an LP gas safety operation associated with the due date data has been already assigned to a safety inspector.

9. The method according claim 2 wherein the safety management system further comprises a safety inspector data storage unit, for storing safety inspector data performing the LP gas safety operation, and wherein the method further comprises:
receiving an assignment instruction for assigning, to individual safety inspectors LP as safety operations associated with the due date data,
in response to receiving the assignment instruction, associating the due date data with the safety inspector data,
receiving scheduled operation dates for LP gas safety operations related to the associated due date data,
registering the received scheduled operation dates,
creating safety operation schedule data for the individual safety inspectors based on the registered scheduled operation dates and the due date data and
transmitting the created schedule data to mobile terminals of the individual safety inspectors.

10. The method according claim wherein the safety management system further comprises a safety inspector data storage unit, for storing safety inspector data performing the LP gas safety operation, and wherein the method further comprises:
receiving air assignment instruction for assigning, to individual safety inspectors, LP gas safety operations associated with the due date data,
in response to receiving the assignment instruction, associating the due date data with the safety inspector data,
receiving scheduled operation dates for LP gas safety operations related to the associated due date data,
registering the received scheduled operation dates,
creating safety operation schedule data for the individual safety inspectors based on the registered scheduled operation dates and the due date data, and
transmitting the created schedule data to mobile terminals of the individual safety inspectors.

11. The method according claim 4 wherein the safety management system further comprises a safety inspector data storage unit, for storing safety inspector data performing the LP gas safety operation, and wherein the method further comprises:
receiving an assignment instruction for assigning, to individual safety inspectors, LP gas safety operations associated with the due date data,
in response to receiving the assignment instruction, associating the due date data with the safety inspector data,
receiving scheduled operation dates for LP gas safety operations related to the associated due date data,
registering the received scheduled operation dates,
creating safety operation schedule data for the individual safety inspectors based on the registered scheduled operation dates and the due date data, and
transmitting the created schedule data to mobile terminals of the individual safety inspectors.

12. The method according to claim 2, further comprising:
receiving operation completion data for LP gas safety operations associated with the due date data;
determining, based on the received operation completion data, whether re-operation is required;
calculating a due date for the re-operation in a case where the re-operation is required, and
calculating a due date for a next operation in a case where the re-operation is not required.

13. The method according to claim 3, further comprising:
receiving operation completion data for LP gas safety operations associated with the due date data;
determining based on the received operation completion data, whether re-operation is required;
calculating a due date for the re-operation in a case where the re-operation is required, and
calculating a due date for a next operation in a case where the re-operation is not required.

14. The method according to claim 4, further comprising:
receiving operation completion data for LP gas safety operations associated with the due date data;
determining, based on the received operation completion data, whether re-operation is required;
calculating a due date for the re-operation in a case where the re-operation is required, and
calculating a due date for a next operation in a case where the re-operation is not required.

15. The method according to claim 5, further comprising:
receiving operation completion data for LP gas safety operations associated with the due date data;
determining, based on the received operation completion data, whether re-operation is required;
calculating a due date for the re-operation in a case where the re-operation is required, and
calculating a due date for a next operation in a case where the re-operation is not required.

16. The method according to claim 6, further comprising:
receiving operation completion data for LP gas safety operations associated with the due date data;
determining, based on the received operation completion data, whether re-operation is required;
calculating a due date for the re-operation in a case where the re-operation is required, and
calculating a due date for a next operation in a case where the re-operation is not required.

17. The method according to claim 7, further comprising:
receiving operation completion data for LP gas safety operations associated with the due date data;
determining, based on the received operation completion data, whether re-operation is required;
calculating a due date for the re-operation in a case where the re-operation is required, and
calculating a due date for a next operation in a case where the re-operation is not required.

18. The method according to claim 8, further comprising:
receiving operation completion data for LP gas safety operations associated with the due date data;
determining, based on the received operation completion data whether re-operation is required;
calculating a due date for the re-operation in a case where the re-operation is required, and
calculating a due date for a next operation in a case where the re-operation is not required.
